(19) United States
(12) Patent Application Publication
(10) Pub. No.: US 2013/0180926 A1
(43) Pub. Date: Jul. 18, 2013

(54) PREPARING MALEIC ACID-ISOPRENOL COPOLYMERS

(71) Applicants: Jürgen DETERING, Limburgerhof (DE); Torben Gädt, Traunstein (DE); Stephan Nied, Neustadt / Wstr. (DE); Andreas Kempter, Neustadt (DE)

(72) Inventors: Jürgen DETERING, Limburgerhof (DE); Torben Gädt, Traunstein (DE); Stephan Nied, Neustadt / Wstr. (DE); Andreas Kempter, Neustadt (DE)

(73) Assignee: BASF SE, Ludwigshafen (DE)

(21) Appl. No.: 13/545,534

(22) Filed: Jul. 10, 2012

Related U.S. Application Data
(60) Provisional application No. 61/510,507, filed on Jul. 22, 2011.

(51) Int. Cl. C09K 15/06; C09K 15/28

(52) U.S. Cl. CPC C09K 15/06; C09K 15/28
USPC 210/698; 526/271; 526/229; 526/172; 526/222; 526/211; 526/79

(57) ABSTRACT

The invention relates to a process for preparing maleic acid-isoprenol copolymers from
a) 30% to 80% by weight of maleic acid,
b) 5% to 60% by weight of isoprenol,
c) 0% to 30% by weight of one or more further ethylenically unsaturated monomers,
   which comprises polymerizing maleic acid, isoprenol and optionally the further ethylenically unsaturated monomer in the presence of a redox initiator and of a chain transfer agent at a temperature in the range from 10 to 80° C.

This invention relates to a process for preparing maleic acid-isoprenol copolymers, to the copolymers themselves and to their use.

The solubility of most substances in water is limited. The prevention of mineral deposits in water-carrying systems is an essential requirement in industrial water treatment in particular. Inorganic substances and salts such as calcium carbonate, magnesium carbonate, magnesium hydroxide, calcium sulfate, barium sulfate and calcium phosphate have low solubility in water. When these dissolved ingredients become concentrated (thickened) in aqueous systems, their solubility product is exceeded, which causes these substances to precipitate and form deposits. The solubility of substances is additionally dependent on temperature and pH. More particularly, many substances such as calcium carbonate, calcium sulfate or magnesium hydroxide have an inverse solubility, i.e., their solubility decreases with increasing temperature. The result is that high process temperatures are frequently the cause of undesirable precipitation and scale formation in cooling and boiler feed water systems, on heat transfer surfaces or in pipework.

Precipitates and deposits of inorganic substances and salts in water-carrying systems are very difficult to remove again, once formed. Any mechanical and chemical cleaning is cost and time intensive and inevitably leads to manufacturing outages.

It is not just in cooling and boiler feed water systems where it is attempted to avoid the formation of calcium carbonate, calcium sulfate, magnesium hydroxide and other salt scale deposits. Seawater desalination by distillation and by membrane processes such as reverse osmosis or electrodialysis is another water-carrying system where it is desired to stop these firm scale deposits forming in the first place. It is especially in thermal seawater desalination systems where both effects, viz., becoming concentrated through evaporation of water, on the one hand, and high process temperatures, on the other, play an important part.

The productivity of desalination systems is limited by the upper process temperature. It is desirable to operate seawater desalination systems at as high an evaporation temperature as possible in order that a very high process efficiency may be achieved and the energy required to produce fresh water may be minimized. Process efficiency is characterized in terms of kilowatt-hours per cubic meter of water (kWh/m³). This parameter can be minimized by running the multiple-stage flash evaporation and multiple-effect evaporation processes at the highest possible process temperatures. Maximum process temperature in these processes is chiefly limited by the ever increasing degree of scale formation as temperature rises. It is known that particularly the deposition of basic magnesium salts such as magnesium hydroxide (brucite) and magnesium carbonate hydroxide (hydromagnesite), and also calcium carbonate and calcium sulfate in thermal desalination systems play a crucial role.

It is known that low molecular weight polyacrylic acids produced by free-radical polymerization and their salts are used as scale inhibitors in industrial water treatment and in seawater desalination because of their dispersing and crystal growth inhibiting properties. The weight average molecular weight (M_{w}) of these polymers should be <50 000 for good performance. Polyacrylic acids with M_{w}<10 000 are often described as particularly effective. One disadvantage with these polymers is that, as the temperature rises, there is an increase in their hardness sensitivity, i.e., the risk that the polymers will precipitate as calcium or magnesium polyacrylates. Another is that polyacrylic acids have only a very low effect with regard to scale deposits of brucite or hydromagnesite.

Polymaleates are possible alternatives to polyacrylates.

EP-A 337 694 relates to the preparation of maleic acid polymer having a number average molecular weight Mₙ of 300-5000 and a polydispersity of <2.5 from 50% to 99.9% by weight of maleic acid and 50% to 0.1% by weight of a water-soluble unsaturated comonomer, and to its use for water treatment. The use as antiscalant and as builder in laundry detergent formulations are expressely mentioned. Comonomers mentioned include unsaturated monocarboxylic acids such as acrylic acid or methacrylic acid, unsaturated dicarboxylic acids such as fumaric acid and itaconic acid, unsaturated alcohols such as isoprenol, (meth)allyl ethers and unsaturated sulfonated compounds such as vinylsulfonic acid and 2-acrylamido-2-methylpropanesulfonic acid. The copolymers are prepared by aqueous polymerization with H₂O₂ as initiator in the presence of 0.5 to 500 ppm of a metal catalyst comprising iron, copper or vanadium ions. No chain transfer agent is used. Carbon dioxide is liberated during the polymerization, in an amount proportional to the amount of H₂O₂. Maleic acid-isoprenol copolymers are prepared in the examples, by performing the polymerization at the boiling point of the aqueous monomer solution. Weight average molecular weights between 1090 and 4780 are reported to have been determined against polyethylene glycol standards.

EP-A 396 303 relates to the preparation of maleic acid polymers from 75% to 100% by weight of maleic acid and 0% to 25% by weight of a further water-soluble monomer by aqueous polymerization with 12 to 150 g of H₂O₂ per mole of the monomer components, 0.3 to 500 ppm of a metal salt of iron, vanadium or copper and an alkaline substance such as alkali metal hydroxide or alkali metal carbonate to neutralize up to 45% of monomers having acidic groups. The comonomers mentioned include unsaturated monocarboxylic acids such as acrylic acid and methacrylic acid, unsaturated dicarboxylic acids such as fumaric acid and itaconic acid, unsaturated alcohols such as isoprenol, (meth)allyl ethers and unsaturated sulfonated compounds such as vinylsulfonic acid and 2-acrylamido-2-methylpropanesulfonic acid. No chain transfer agent is used. The polymerization temperature is said to be in the range from 85 to 160° C. Copolymers of 80% by weight of maleic acid and 20% by weight of isoprenol are prepared in the examples with number average molecular weights between 2400 and 4100. The polymerization is performed at the boiling point of the monomer mixture. The copolymers are said to be used as laundry detergent builders and antiscalants.

EP-A 302 406 describes the alternating 1:1 copolymerization of isoprenol acetate with maleic anhydride and further maleic acid derivatives in organic solvents such as cyclohexane or diethyl ether. The polymerization temperature is 60° C., and the initiator used is azobis(isobutyronitrile) (AIBN). The minimum polymerization time is 5 hours for maleic anhydride and isoprenol acetate from cyclohexane. The molecular weights obtained are between 5600 to 190 000 g/mol. The polymers are used as hot-melt adhesives and water absorbents.

The problem addressed by the present invention is that of providing polymers having improved scale-inhibiting performance, which are effective in inhibiting precipitates and deposits of calcium carbonate, calcium sulfate and basic magnesium salts in water-carrying systems in particular, and also a process for preparation thereof.

The problem is solved by a process for preparing maleic acid-isoprenol copolymers from

a) 30% to 80% by weight of maleic acid,
b) 5% to 60% by weight of isoprenol,
c) 0% to 30% by weight of one or more further ethylenically unsaturated monomers,
which comprises polymerizing maleic acid, isoprenol and optionally the further ethylenically unsaturated monomer in the presence of a redox free-radical initiator and of a chain transfer agent at a temperature in the range from 10 to 80° C. Maleic acid can also be used in the form of maleic anhydride.

The problem is also solved by the thus obtainable maleic acid-isoprenol copolymers themselves and by their use as scale inhibitors in water-carrying systems.

Surprisingly, copolymers of maleic acid and isoprenol which are prepared by redox-initiated polymerization at low temperatures of 10 to 80° C. are found to be very useful for inhibiting the formation of basic magnesium salt scale deposits and also calcium carbonate and calcium sulfate scale deposits.

Preferably, the maleic acid-isoprenol copolymers obtained have a weight-average molecular weight in the range from 3000 to 20 000 g/mol. Their isoprenol content is between 5% and 60% by weight. The copolymers of the present invention are particularly notable for being obtained by a particularly mild polymerization process where there is no occurrence of secondary reactions such as the isomerization of isoprenol to prenol or dimethylvinylcarbinol, the formation of 3-methyl-1,3-butandiol or isoprene or the decarboxylation of maleic acid.

Existing processes for preparing maleic acid-isoprenol copolymers are based on a free-radical polymerization at elevated temperatures around 100° C. It is known that isoprenol in particular is subject to rapid chemical degradation under acidic conditions and high temperatures (F. Lynen, Liebigs Ann. Chem. 1960, 360, 58 to 70). By contrast, the process of the present invention provides a significantly milder polymerization reaction at temperatures between 10 to 80° C. This is effective in preventing any degradation of the isoprenol. The polymerization temperature is preferably in the range from 10 to 70° C. and more preferably in the range from 10 to 60° C.

The process of the present invention provides maleic acid-isoprenol copolymers obtained using chain transfer agents. They make it possible to set the desired molecular weight in a range from 3000 to 20 000 g/mol. The weight average molecular weight of the isoprenol-maleic acid copolymers is generally in the range from 3000 to 20 000 g/mol, preferably in the range from 3500 to 14 000 g/mol, more preferably in the range from 4000 to 10 000 g/mol and more particularly in the range from 4000 to 8000 g/mol.

Molecular weight is determined via gel permeation chromatography against polyacrylic acid standards whose absolute molecular weight distribution was determined via light scattering.

The M_{w}/Mₙ polydispersity index of the maleic acid-isoprenol copolymer is generally ≦2.5 and preferably ≦2.

In general, the redox initiator comprises a peroxide and a reducing agent.

Useful peroxides include for example hydrogen peroxide, sodium peroxodisulfate, potassium peroxodisulfate, ammonium peroxodisulfate, tert-butyl hydroperoxide, dibenzoyl peroxide and cumyl hydroperoxide. In one preferred embodiment, the initiator comprises hydrogen peroxide. Hydrogen peroxide is generally used as an aqueous solution, for example with a hydrogen peroxide content of 30% by weight.

Useful reducing agents include for example iron(II) salts, sodium hydroxymethanesulfinate (available as Rongalit or Brüggolit SFS for example), sodium 2-hydroxy-2-sulfinatoacetic acid (available as Brüggolit FF06 for example), ascorbic acid, alkali metal sulfites, alkali metal metabisulfites, sodium hypophosphite and thiourea. In a preferred embodiment, the initiator comprises sodium hydroxymethanesulfinate or sodium 2-hydroxy-2-sulfinatoacetic acid as reducing agent.

In a further embodiment, the initiator comprises an iron salt in addition to the peroxide and the reducing agent.

In a particularly preferred embodiment, the redox initiator comprises hydrogen peroxide, an iron salt and a reducing agent.

Useful chain transfer agents include inorganic sulfur compounds such as hydrogensulfites, disulfites and dithionites, organic sulfides, sulfoxides, sulfones and mercapto compounds such as mercaptoethanol, mercaptoacetic acid and also inorganic phosphorus compounds such as hypophosphorous acid (phosphinic acid) and its salts, for example sodium hypophosphite.

In a preferred embodiment, the chain transfer agent comprises a mercapto compound, particularly mercaptoethanol.

The process of the present invention is generally carried out semicontinuously in feed stream addition mode. Water is generally used as solvent. The water is at least partly included in the initial charge.

In one version, the maleic acid and also optionally some of the isoprenol is present in the initial charge and at least some of the isoprenol is added as a feed stream. Maleic acid can also be used in the form of maleic anhydride. In an advantageous version, the entire amount of isoprenol is added as feed stream.

Isoprenol can also be wholly included in the initial charge. In a further advantageous version, both maleic acid and isoprenol are fully included in the initial charge. Maleic acid can also be used in the form of maleic anhydride.

Preferably, the copolymers of the present invention comprise a) 35% to 75% by weight of maleic acid and b) 15% to 50% by weight of isoprenol, and c) 0% to 30% by weight of a further ethylenically unsaturated monomer.

In one embodiment of the invention, the copolymers comprise a) 50% to 75% by weight and preferably 55% to 75% by weight of maleic acid, and b) 25% to 50% by weight and preferably 25% to 45% by weight of isoprenol and no further ethylenically unsaturated monomer. Weight particulars are based on the free acid. But maleic acid can also be present in the form of its salts.

The maleic acid-isoprenol copolymer may comprise up to 30% by weight, preferably up to 25% by weight and more preferably up to 20% by weight, based on all ethylenically unsaturated monomers, of one or more further ethylenically unsaturated monomers in copolymerized form. Examples of suitable ethylenically unsaturated comonomers are acrylic acid, methacrylic acid, vinylsulfonic acid, allylsulfonic acid and 2-acrylannido-2-methylpropanesulfonic acid. Weight particulars are based on the free acid. The comonomers can also be present in the form of their salts.

In one embodiment of the invention, the copolymer comprises acrylic acid by way of further monomer, preferably in amounts of 5 to 25% by weight. In a further embodiment of the invention, the copolymer comprises 2-acrylamido-2-methylpropanesulfonic acid by way of further monomer, preferably in amounts of 5% to 25% by weight.

In an advantageous embodiment of the invention, the copolymers comprise a) 35% to 75% by weight and preferably 35% to 60% by weight of maleic acid, and b) 15% to 50% by weight and preferably 20% to 45% by weight of isoprenol and c) 2 to 30% by weight and preferably 5 to 25% by weight of a further ethylenically unsaturated monomer, especially acrylic acid and/or 2-acrylamido-2-methylpropanesulfonic acid.

The further unsaturated monomer c) may both be included in the initial charge and added as a feed stream. In general, at least some of the further monomer c) is added as a feed stream. In one version, the entire amount of further monomer c) is added as a feed stream.

The chain transfer agent may be included in the initial charge or added as feed stream. In general, at least some of the chain transfer agent is added as feed stream.

The reducing agent may be included in the initial charge or added as feed stream. In general, at least some of the reducing agent is added as feed stream.

The peroxide may be included in the initial charge or added as feed stream. In one version, the entire peroxide is included in the initial charge. In a further version, at least some of the peroxide is added as feed stream. Preferably, the entire hydrogen peroxide is added as feed stream.

More particularly, hydrogen peroxide, reducing agent and chain transfer agent are added at least in part and as multiple separate feed streams.

In a preferred embodiment, the redox initiator comprises an iron salt as well as hydrogen peroxide and reducing agent. This iron salt is preferably entirely included in the initial charge.

The polymerization mixture may comprise aqueous alkali metal hydroxide solution to neutralize maleic acid or further ethylenically unsaturated monomers having acidic groups. Aqueous alkali metal hydroxide solution may be entirely included in the initial charge or at least partly added as feed stream. Preferably, the aqueous sodium hydroxide solution used to partially neutralize the maleic acid is entirely included in the initial charge. When a further ethylenically unsaturated monomer c) having acidic groups is added as a feed stream, then alkali metal hydroxide solution is generally also added with the feed stream.

More particularly, the polymerization is performed in aqueous solution having a monomer content of 25% to 50% by weight. The free-radical polymerization is carried out under acidic conditions, generally at a pH of 0.5 to 6.5.

It is particularly preferable for the polymerization to be performed at temperatures ≦60° C. Polymerization temperatures ≦50° C. are especially preferable.

Water-carrying systems in which the maleic acid-isoprenol copolymers can be used are more particularly seawater desalination systems, brackish water desalination systems, cooling water systems and boiler feed water systems.

The polymers of the present invention are generally added to the water-carrying systems in amounts from 0.1 mg/l to 100 mg/l. Optimum dosage depends on the requirements of the particular application and/or the operating conditions of the particular process. Thermal seawater desalination preferably utilizes the polymers in concentrations of 0.5 mg/l to 10 mg/l. Industrial cooling circuits or boiler feed water systems utilize polymer concentrations up to 100 mg/l. Water analyses are frequently carried out to determine the proportion of scale-forming salts and hence optimum dosage.

The polymers of the present invention can also be added to the water-carrying systems in formulations which, in addition to the polymers of the present invention, may inter alia comprise phosphonates, polyphosphates, zinc salts, molybdate salts, organic corrosion inhibitors such as benzotriazole, tolyltriazole, benzimidazole or ethynylcarbinol alkoxylates, biocides, complexing agents and/or surfactants. Examples of phosphonates are 1-hydroxyethane-1,1-diphosphonic acid (HEDP), 2-phosphonobutane-1,2,4-tricarboxylic acid (PBTC), aminotrimethylenephosphonic acid (ATMP) diethylenetriaminepenta(methylenephosphonic acid) (DTPMP) and ethylenediaminetetra(methylenephosphonic acid) (EDTMP), which are each used in acid form or in the form of their sodium salts.

The examples which follow illustrate the invention.

### EXAMPLES

Average molecular weights were determined via GPC.
Apparatus: Waters Alliance 2690 with UV detector (Waters 2487) and RI-detector (Waters 2410)
Columns: Shodex OHpak SB 804HQ and 802.5HQ
   (PHM gel, 8×300 mm, pH 4.0 to 7.5)
Eluent: 0.05 M aqueous ammonium formate/methanol mixture=80:20 (parts by volume)
Flow rate: 0.5 mL/min
Temperature: 50° C.
Injection: 50 to 100 μL
Detection: RI and UV

Molecular weights of polymers were determined using two different calibrations: first relative to polyethylene glycol standards from PSS Polymer Standards Service GmbH and secondly relative to polyacrylic acid standards from Varian Inc. Molecular weight distribution curves of polyethylene glycol standards and polyacrylic acid standards were determined via light scattering. The polyethylene glycol standards had masses of 682 000, 164 000, 114 000, 57 100, 40 000, 26 100, 22 100, 12 300, 6240, 3120, 2010, 970, 430, 194, 106 g/mol. The polyacrylic acid standards had masses of 115 000, 47 500, 28 000, 16 000, 7500, 4500, 4100, 2925, 1250 g/mol.

For comparison, the weight average molecular weight determined against polyethylene glycol standards is also reported in Tables 1 and 2. Polyethylene glycol is nonionic and so less suitable for use as standard than polyacrylic acid and systematically gives higher molecular weights than polyacrylic acid.

### Synthesis Examples

### Inventive Example 1

A 1 L double-wall reactor with mechanical stirring system is filled with 196 g of maleic anhydride, 112 g of isoprenol, 40 mg of iron sulfate heptahydrate (FeSO₄×7H₂O) and 400 g of water. Then, 8 g of 50% by weight aqueous sodium hydroxide solution are added. The initially charged solution is cooled down to 10° C. by an external thermostat. Temperature and pH sensors dip into the reaction mixture. As soon as the reaction mixture has reached 10° C., three separate feed streams are started: 1) 10 g of Rongalit in 90 g of water, 2) 25 g of 30% by weight aqueous hydrogen peroxide solution, 3) 2 g of 2-mercaptoethanol in 25 g of water. Feed stream 1) is added over 60 minutes at a rate of 40 mL/h. Feed stream 2) is added over 30 minutes at a rate of 45 mL/h, and feed stream 3) is added over 60 minutes at a rate of 27 mL/h.

This gives a clear low-viscosity solution having a slightly yellowish color and a pH of 1.8. The solids content of the solution is 40% and the molecular weight M_{w} (GPC versus polyacrylic acid standards) is 11 000 g/mol.

### Inventive Example 2

A 1 L double-wall reactor with mechanical stirring system is filled with 196 g of maleic anhydride, 112 g of isoprenol, 4 g of 2-mercaptoethanol, 40 mg of iron sulfate heptahydrate (FeSO₄×7H₂O) and 400 g of water. Then, 8 g of 50% by weight aqueous sodium hydroxide solution are added. The initially charged solution is cooled down to 10° C. by an external thermostat. Temperature and pH sensors dip into the reaction mixture. As soon as the reaction mixture has reached 10° C., three feed streams are started: 1) 10 g of Rongalit in 90 g of water, 2) 25 g of 30% by weight aqueous hydrogen peroxide solution, 3) 8 g of 2-mercaptoethanol in 25 g of water. Feed stream 1) is added over 50 minutes at a rate of 40 mL/h. Feed stream 2) is added over 30 minutes at a rate of 45 mL/h, and feed stream 3) is added over 50 minutes at a rate of 33 mL/h.

This gives a clear low-viscosity solution having a slightly yellowish color and a pH of 1.9. The solids content of the solution is 43% and the molecular weight M_{w} (GPC versus polyacrylic acid standards) is 6000 g/mol.

### Inventive Example 3

A 1 L double-wall reactor with mechanical stirring system is filled with 196 g of maleic anhydride, 129 g of isoprenol, 40 mg of iron sulfate heptahydrate (FeSO₄×7H₂O) and 400 g of water. Then, 8 g of 50% by weight aqueous sodium hydroxide solution are added. The initially charged solution is cooled down to 10° C. by an external thermostat. Temperature and pH sensors dip into the reaction mixture. As soon as the reaction mixture has reached 10° C., three feed streams are started: 1) 10 g of Rongalit in 90 g of water, 2) 25 g of 30% by weight aqueous hydrogen peroxide solution, 3) 6 g of 2-mercaptoethanol in 25 g of water. Feed stream 1) is added over 60 minutes at a rate of 40 mL/h. Feed stream 2) is added over 30 minutes at a rate of 45 mL/h, and feed stream 3) is added over 60 minutes at a rate of 31 mL/h.

This gives a clear low-viscosity solution having a slightly yellowish color and a pH of 1.9. The solids content of the solution is 42% and the molecular weight M_{w} (GPC versus polyacrylic acid standards) is 7500 g/mol.

### Inventive Example 4

A 0.5 L double-wall reactor with mechanical stirring system is filled with 98 g of maleic anhydride, 65 g of isoprenol, 1 g of 2-mercaptoethanol, 20 mg of iron sulfate heptahydrate (FeSO₄×7H₂O) and 200 g of water. Then, 4 g of 50% by weight aqueous sodium hydroxide solution are added. The initially charged solution is cooled down to 10° C. by an external thermostat. Temperature and pH sensors dip into the reaction mixture. As soon as the reaction mixture has reached 10° C., three feed streams are started: 1) 5 g of Rongalit in 45 g of water, 2) 12.5 g of 30% by weight aqueous hydrogen peroxide solution, 3) 9 g of 2-mercaptoethanol in 10 g of water. Feed stream 1) is added over 50 minutes at a rate of 20 mL/h. Feed stream 2) is added over 30 minutes at a rate of 22.5 mL/h, and feed stream 3) is added over 50 minutes at a rate of 19 mL/h.

This gives a clear low-viscosity solution having a slightly yellowish color and a pH of 2.2. The solids content of the solution is 44% by weight and the molecular weight M_{w} (GPC versus polyacrylic acid standards) is 4000 g/mol.

### Inventive Example 5

A 1 L double-wall reactor with mechanical stirring system is filled with 196 g of maleic anhydride, 1 g of 2-mercaptoethanol, 40 mg of iron sulfate heptahydrate (FeSO₄×7H₂O) and 400 g of water. This solution is cooled down to 10° C. by an external thermostat. Temperature and pH sensors dip into the reaction mixture. As soon as the reaction mixture has reached 10° C., 40 g of 30% by weight aqueous sodium hydroxide solution are added. Subsequently, three feed streams are started: 1) 10 g of Rongalit in 90 g of water, 2) 172 g of isoprenol, 3) 3 g of 2-mercaptoethanol in 25 g of water. Feed stream 1) is added over 80 minutes at a rate of 40 mL/h. Feed stream 2) is added over 50 minutes at a rate of 242 mL/h, and feed stream 3) is added over 60 minutes at a rate of 28 mL/h.

This gives a clear low-viscosity solution having a slightly yellowish color and a pH of 1.9. The solids content of the solution is 38% and the molecular weight M_{w} (GPC versus polyacrylic acid standards) is 5450 g/mol.

### Inventive Example 6

A 0.5 L double-wall reactor with mechanical stirring system is filled with 34 g of maleic anhydride, 43 g of isoprenol, 0.25 g of 2-mercaptoethanol, 10 mg of iron sulfate heptahydrate (FeSO₄×7H₂O) and 70 g of water. Then, 1.5 g of 50% by weight aqueous sodium hydroxide solution are added. This solution is cooled down to 20° C. by an external thermostat. Temperature and pH sensors dip into the reaction mixture. As soon as the reaction mixture has reached 20° C., 10 g of 30% by weight aqueous sodium hydroxide solution are added. Subsequently, three feed streams are started: 1) 5 g of Rongalit in 45 g of water, 2) a mixture of 28 g of 90% by weight acrylic acid, 30 g of water and 1.5 g of 50% aqueous sodium hydroxide solution, 3) 3.75 g of 2-mercaptoethanol in 15 g of water. Feed stream 1) is added over 70 minutes at a rate of 15 mL/h. Feed stream 2) is added over 60 minutes at a rate of 56 mL/h, and feed stream 3) is added over 60 minutes at a rate of 19 mL/h.

This gives a clear low-viscosity solution having a slightly yellowish color and a pH of 2.0. The solids content of the solution is 43% and the molecular weight M_{w} (GPC versus polyacrylic acid standards) is 4000 g/mol.

### Inventive Example 7

A 0.5 L double-wall reactor with mechanical stirring system is filled with 49 g of maleic anhydride, 49 g of isoprenol, 0.25 g of 2-mercaptoethanol, 10 mg of iron sulfate heptahydrate (FeSO₄×7H₂O) and 100 g of water. Then, 4 g of 50% by weight aqueous sodium hydroxide solution are added. This solution is cooled down to 20° C. by an external thermostat. Temperature and pH sensors dip into the reaction mixture. As soon as the reaction mixture has reached 20° C., four feed streams are started: 1) 5 g of Rongalit in 45 g of water, 2) 7 g of 30% by weight aqueous hydrogen peroxide solution, 3) 2 g of 2-mercaptoethanol in 10 g of water, 4) 49 g of 50% by weight aqueous 2-acrylamido-2-methylpropanesulfonic acid (AMPS) solution. Feed stream 1) is added over 40 minutes at a rate of 10 mL/h. Feed stream 2) is added over 30 minutes at a rate of 12.6 mL/h, and feed stream 3) is added over 30 minutes at a rate of 12 mL/h and feed stream 4) is added over 20 minutes at a rate of 123 mL/h.

This gives a clear low-viscosity solution having a slightly yellowish color and a pH of 2.6. The solids content of the solution is 43% and the molecular weight M_{w} (GPC versus polyacrylic acid standards) is 7000 g/mol.

### Comparative Example A

A 500 mL double-wall reactor with mechanical stirring system is filled with 98 g of maleic anhydride, 23 mg of iron sulfate heptahydrate (FeSO₄×7H₂O) and 38 g of water. Thereafter, the reaction mixture is heated to 90° C. while the temperature and the pH are continuously recorded via sensors. After the temperature of the reaction mixture has reached 90° C., two feed streams are started at the same time. Feed stream 1 consists of 86 g of isoprenol and is added over 180 minutes at a rate of 34 mL/h. Feed stream 2 consists of a 30% by weight aqueous hydrogen peroxide solution and is added over 180 minutes at a rate of 23 mL/h. Subsequently, the reaction mixture is maintained at 90° C. for a further 60 minutes.

This gives a slightly viscous, intensively yellow-orange solution having a pH of 2.8. The solids content of the solution is 62% and the molecular weight (GPC) is 2500 g/mol.

### Comparative Example B

### Corresponding to Example 9 of EP-A 396 303

A 500 mL double-wall reactor with mechanical stirring system is filled with 98 g of maleic anhydride, 23 mg of iron sulfate heptahydrate (FeSO₄×7H₂O) and 38 g of water. Thereafter, the reaction mixture is heated to 90° C. while the temperature and the pH are continuously recorded via sensors. After the temperature of the reaction mixture has reached 90° C., two feed streams are started at the same time. Feed stream 1 consists of 34 g of isoprenol and is added over 180 minutes at a rate of 13 mL/h. Feed stream 2 consists of a 30% by weight aqueous hydrogen peroxide solution and is added over 180 minutes at a rate of 23 mL/h. Subsequently, the reaction mixture is maintained at 90° C. for a further 60 minutes.

This gives a slightly viscous, intensively yellow-orange solution having a pH of 2.4. The solids content of the solution is 55% and the molecular weight (GPC) is 2000 g/mol.

### Comparative Example C

### Polyacrylic Acid C

A reactor was initially charged with 304.0 g of completely ion-free water together with 1.84 g of a 50% by weight aqueous solution of phosphorous acid followed by heating under nitrogen to 98° C. internal temperature. At this temperature, 461.0 g of a distilled acrylic acid, 132.0 g of a 7% by weight aqueous sodium peroxodisulfate solution and 196.0 g of 40% by weight aqueous sodium bisulfite solution were added separately and concurrently under agitation. Acrylic acid was added within 4 hours, sodium peroxodisulfate within 4.25 hours and sodium bisulfite within 3.75 hours. On completion of the acrylic acid feed 496.0 g of a 50% by weight aqueous sodium hydroxide solution were added at 98° C. internal temperature within 1 hour, followed by secondary polymerization at 98° C. for 1 hour. Thereafter, the polymer solution was cooled down to room temperature to obtain a clear, slightly viscous polymer solution having a pH of 6.9 and a solids content of 43.5%. The weight average molecular weight (Mw) is 4450 g/mol,

### Use of Copolymers as Scale Inhibitors

The polymer solutions were adjusted to pH 7 with dilute NaOH.

### Example 8

### Calcium Carbonate Inhibition Test

A solution of NaHCO₃, Mg₂SO₄, CaCl₂ and copolymer is shaken at 70° C. and a pH of 8.0-8.5 in a water bath for 2 h. After the still warm solution has been filtered through a 0.45 μm Milex filter, the Ca content of the filtrate is determined complexometrically or by means of a Ca²⁺-selective electrode and the CaCO₃ inhibition is determined in % by before/after comparison in accordance with the formula hereinbelow. The concentrations of the various ions and of the copolymer are as follows:

| | |
|---|---|
| Ca²⁺ | 215 mg/L |
| Mg²⁺ | 43 mg/L |
| HCO₃⁻ | 1220 mg/L |
| Na⁺ | 460 mg/L |
| Cl⁻ | 380 mg/L |
| SO₄²⁻ | 170 mg/L |
| Polymer | 3 mg/L |

CaCO₃ inhibition (%)=mg (Ca²⁺) after 24 h−mg (Ca²⁺) blank value after 24 h/mg (Ca²⁺) zero value−mg (Ca²⁺) blank value after 24 h×100

The results are reported in Table 1

TABLE 1

| | | Mw | Mw | CaCO₃ |
|---|---|---|---|---|
| | MS:isoprenol | [g/mol] | [g/mol] | inhibition |
| | weight ratio | (a) | (b) | % |
| Example | | | | |
| 1 | 68:32 | 11 000 | 26 700 | 61.3 |
| 2 | 68:32 | 6000 | 17 300 | 67.3 |
| 3 | 64:36 | 7500 | 22 500 | 67.0 |
| 4 | 64:36 | 4000 | 10 700 | 56.7 |
| 5 | 57:43 | 5500 | 12 000 | 68.9 |
| Comparative | | | | |
| examples | | | | |
| A | 57:43 | 2500 | 4900 | 46.7 |
| B | 77:23 | 2000 | 4100 | 51.0 |
| C polyacrylic acid C | — | 4500 | | 60.0 |

(a) determined by GPC versus polyacrylic acid standards
(b) determined by GPC versus poly(ethylene glycol) standards
MS = maleic acid

### Example 9

### Tests on Inhibiting Basic Mg Salt Deposits by DSL Method

The scale-inhibiting effect of inventive copolymers is tested using a modified version of the differential scale loop (DSL) instrument from PSL Systemtechnik. This is a tube blocking system in the form of a fully automated laboratory rig for investigating precipitates and deposits of salts in pipelines and water-carrying pipework. In this apparatus, operated in a modified procedure, a magnesium chloride solution A is mixed together with a sodium bicarbonate solution B, comprising the polymer to be tested, at a temperature of 120° C. and a specific pressure of 2 bar at a mixing point in a volume ratio of 1:1 and pumped through a stainless steel test capillary at constant temperature and constant flow rate. The pressure difference between the mixing point (upstream end of the capillary) and the downstream end of the capillary is determined. An increase in the pressure difference indicates scale formation by basic magnesium salts (hydromagnesite, brucite) within the capillary. The time to a pressure increase of defined magnitude (0.1 bar) is a measure of the scale-inhibiting effect of the polymer used.

The experimental conditions are:

### Solution A: 100 mM MgCl₂

### Solution B: 200 mM NaHCO₃

Concentration of polymer after mixing of A and B: 10 mg/l
Capillary length: 2.5 m
Capillary diameter: 0.88 mm
Capillary material: stainless steel

### Temperature: 120° C.

Total flow rate: 5 ml/min
System pressure: 2 bar
Pressure increase threshold value: 0.1 bar

The results are summarized in Table 2. The average formed from 4 individual measurements is reported in each case.

TABLE 2

| | | Mw g/mol | Mw g/mol | Time |
|---|---|---|---|---|
| | MS:isoprenol | (a) | (b) | [min] |
| Example | | | | |
| no polymer | | | | 4.5 |
| 1 | 68:32 | 11 000 | 26 700 | 30.2 |
| 3 | 64:36 | 7500 | 22 500 | 41.1 |
| 4 | 64:36 | 4000 | 10 700 | 21.2 |
| 5 | 57:43 | 5500 | 12 000 | 40.8 |
| | MS:AS:isoprenol | | | |
| 6 | 37:23:40 | 4000 | 9200 | 28.4 |
| | MS:isoprenol: | | | |
| | AMPS | | | |
| 7 | 44:37:19 | 7000 | 12 700 | 37.6 |
| Comparative | | | | |
| examples | | | | |
| A | 57:43 | 2500 | 4900 | 18.5 |
| B | 77:23 | 2000 | 4100 | 13.4 |
| C polyacrylic acid C | | 4500 | | 7.1 |

(a) determined by GPC versus polyacrylic acid standards
(b) determined by GPC versus poly(ethylene glycol) standards
MS = maleic acid
AS = acrylic acid
AMPS = 2-acrylamido-2-methylpropanesulfonic acid

1. A process for preparing maleic acid-isoprenol copolymers from
a) 30% to 80% by weight of maleic acid,
b) 5% to 60% by weight of isoprenol,
c) 0% to 30% by weight of one or more further ethylenically unsaturated monomers,
which comprises polymerizing maleic acid, isoprenol and optionally the further ethyllenically unsaturated monomer in the presence of a redox initiator and of a chain transfer agent at a temperature in the range from 10 to 80° C.

2. The process according to claim 1 wherein the redox initiator comprises a peroxide and a reducing agent.

3. The process according to claim 2 wherein the redox initiator further comprises an iron salt.

4. The process according to claim 2 wherein the redox initiator comprises hydrogen peroxide.

5. The process according to claim 2 wherein the redox initiator comprises sodium hydroxymethanesulfinate or sodium 2-hydroxy-2-sulfinatoacetic acid as reducing agent.

6. The process according to claim 2 wherein the chain transfer agent comprises a mercapto compound.

7. The process according to claim 1 wherein the process is carried out semicontinuously in a feed stream addition operation wherein maleic acid and also optionally some of the isoprenol is present in the initial charge and at least some of the isoprenol is added as a feed stream.

8. The process according to claim 1 wherein maleic acid and isoprenol are fully included in the initial charge.

9. The process according to claim 7 wherein at least some of the further ethylenically unsaturated monomer is added as a feed stream.

10. The process according to claim 7 wherein at least some of the chain transfer agent is added as a feed stream.

11. The process according to claim 7 wherein at least some of the reducing agent is added as a feed stream.

12. The process according to claim 7 wherein at least some of the peroxide is added as a feed stream.

13. The process according to claim 7 wherein an iron salt is included in the initial charge.

14. A maleic acid-isoprenol copolymer obtainable by a process according to claim 1.

15. A method of use of the maleic acid-isoprenol copolymer according to claim 14 as a scale inhibitor in a water-carrying system, comprising the step of adding the maleic acid-isoprenol copolymer in an amount of from 0.1 mg/L to the water-carrying system.

16. A method of use according to claim 15 wherein the water-carrying systems are seawater desalination systems, brackish water desalination systems, cooling water systems and boiler feed water systems.
